(19) United States
(12) Patent Application Publication
(10) Pub. No.: US 2015/0194697 A1
(43) Pub. Date: Jul. 9, 2015

(54) STACKED BATTERY TRAY STRUCTURE AND RELATED METHODS

(71) Applicants: Ming Wei Hung, Alhambra, CA (US); Didier Sagan, San Diego, CA (US)

(72) Inventors: Ming Wei Hung, Alhambra, CA (US); Didier Sagan, San Diego, CA (US)

(21) Appl. No.: 14/592,484

(22) Filed: Jan. 8, 2015

Related U.S. Application Data
(60) Provisional application No. 61/924,991, filed on Jan. 8, 2014.
(60) Provisional application No. 62/033,561, filed on Aug. 5, 2014.

(51) Int. Cl. H01M 10/04; H01M 2/10; H01M 2/20; H01M 10/0562

(52) U.S. Cl. CPC H01M 10/0436; H01M 10/0562; H01M 2/1022; H01M 2/204; H01M 2220/30

(57) ABSTRACT

Thin-film batteries are stacked within a structure that permits battery expansion. In various embodiments, the batteries are retained within individual trays that may be tiled into multi-tray layers which are then stacked, or are retained within a stacked series of printed circuit boards or within the pleats of a single, flexible, accordion-folded printed circuit board.

### CROSS-REFERENCE TO RELATED APPLICATIONS

This application claims priority to and the benefit of U.S. Provisional Patent Application Nos. 61/924,991, filed on Jan. 8, 2014, and 62/033,561, filed on Aug. 5, 2014 the entire disclosures of which is hereby incorporated herein by reference.

### FIELD OF THE INVENTION

In various embodiments, the present invention relates generally to stacked solid-state batteries and manufacturing techniques for producing such batteries in various configurations.

### BACKGROUND

Solid-state rechargeable batteries (SSRBs) have numerous applications in portable consumer devices and MEMS applications. Such batteries are intrinsically safer than conventional batteries containing liquid electrolytes as there is no threat of fluid-electrolyte leakage or transition to a thermal-runaway heating mode when shorted. These safety attributes, coupled with the high energy densities of solid-state batteries, make them especially desirable in implantable medical devices.

Current commercial SSRBs have capacities in the sub-0.1 milliampere-hour (mAh) range. Because of their low capacities, they are most often used in timekeeping applications or to provide an energy buffer in energy-harvesting applications. Since most conventional applications require capacity in excess of 10 mAh, SSRBs are rarely used as the sole energy source due to the number of cells, connected in parallel, that would be required. But for very low-power devices, such as small medical implants, for which volume is extremely limited and safety is critical, using SSRB cells in parallel is a viable and attractive solution.

Because solid-state batteries are typically very thin (e.g., 100-200 μm), it is often optimal to stack battery cells on top of each other to form a practical volume. However, this configuration poses challenges. First, SSRBs, like other rechargeable batteries, expand slightly during charge. The stacked configuration must leave enough room or compliance for this expansion while still providing sufficient mechanical integrity. Second, SSRBs are very small, but the volume needed to implement the connections to the battery terminals, typically using wire bonding, is not negligible. Stacking can easily exacerbate the problem and significantly affect the volume efficiency (mAh/mm³).

Commercial implementations are relatively few. One approach, indicated at 101 in FIG. 1, is to stack battery cells 105 in a staggered configuration so that the terminals of each cell are exposed. The electrical connections are then created by wire bonding from those terminals to an underlying substrate 150. This solution is limited to very few cells (two to four) because of the length of the wire bonding and other constraints. The wire-bonding problem can be reduced by wiring from the top cell to the cell below and so forth until the last step from the bottom cell to the substrate. However, the overhang created by the stepped shifts on the opposite side of the terminals, coupled with the need for a compliant layer between cells to accommodate expansion during use, limit the number of cells that can be stacked with adequate mechanical stability. Overall, the relatively large volume used by the wire bonding as well as the empty volume under the stepped overhang significantly limits the volume efficiency that can be achieved, particularly as the number of cells increases.

Over the years, many incremental improvements in increasing energy density and minimizing cycle loss have been made by modifying the composition of substrates, solid electrolytes, anodes, and cathodes. Many of these improvements further contribute to space inefficiency by increasing the package size, especially as thin-film batteries must be hermetically sealed or packaged to minimize oxygen permeability to minimize anode and oxygen interaction which reduces battery life.

Accordingly, there is a need for improved techniques for arranging SSRBs in a manner that minimizes occupied volume while maintaining mechanical integrity and convenient connection to circuitry.

### SUMMARY

Embodiments of the invention provide a novel approach to stacking SSRBs in a manner that provides the compliance necessary to accommodate expansion during use while minimizing occupied volume. In various embodiments, the batteries are retained within individual trays that may be tiled into multi-tray layers which are then stacked, or are retained within a stacked series of printed circuit boards or within the pleats of a single, flexible, accordion-folded printed circuit board, in each case in a manner that permits battery expansion.

Accordingly, in a first aspect, the invention relates to battery array comprising, in various embodiments, a plurality of thin-film batteries each having first and second opposed surfaces and a thickness spanning the surfaces, where the batteries have a generally polygonal (e.g., square) shape; and a plurality of battery trays. Each of the trays may have at least one battery well and an associated battery received therein, and each of the battery wells may comprise (i) a floor in contact with a first surface of the associated battery, (ii) a side wall having a height greater than the thickness of the associated battery, and (iii) first and second electrical contacts on an exterior surface of the side wall, with each of the contacts being electrically connected to a different pole of the associated battery. The battery trays may be arranged in stacked relation, with the first electrical contacts interconnected with each other and the second electrical contacts interconnected with each other but not with the first electrical contacts. In each well, a second surface of the associated battery opposed to the battery first surface is spaced apart from any surface of any tray stacked thereabove.

In some embodiments, each of the battery trays has first and second battery wells arranged side-by-side. In a particular implementation there are four wells arranged in a square, tiled configuration; a first pair of battery trays adjacent along a first axis has electrical contacts in a first configuration and a second pair of battery trays adjacent to each other along the first axis and adjacent to the first pair of battery trays along a second axis perpendicular to the first axis has electrical contacts in a second configuration different from the first configuration. A first conductive epoxy may interconnect the first electrical contacts, a second conductive epoxy may interconnect the second electrical contacts, and a non-conductive epoxy may separate the first and second electrical contacts.

In some embodiments, the battery array further comprises first and second interdigitated conductors along a sidewall thereof. The first conductor is connected to the first electrical contacts and the second conductor is separately connected to the second electrical contacts.

Each of the battery wells may further comprise a compliant pad over the associated battery. For example, the compliant pad may comprise, consist of, or consist essentially of silicone, low-durometer epoxy, and/or a gas layer. The trays may comprise, consist of, or consist essentially of polyester, polyethylene, or polypropylene.

In some embodiments, the stacked battery trays are bonded together or encapsulated. The batteries may be LiPON thin-film solid-state batteries.

In another aspect, the invention relates to a battery array comprising, in various embodiments, a plurality of thin-film batteries each having first and second opposed surfaces and a thickness spanning the surfaces, where the batteries have a generally polygonal (e.g., square) shape; a flexible printed circuit board folded in an accordion fashion to create pairs of opposed board surfaces, where each pair of opposed surfaces has at least one battery received therebetween; first and second electrical contacts on an exposed surface of the flexible printed circuit board, where each of the contacts is electrically connected to a different pole of all of the batteries; and a compliant pad over each battery. The battery array may further comprise a support structure—e.g., an external wrap consisting of stretch wrap or heat shrink tubing—for retaining the flexible printed circuit board in a folded configuration. The compliant pad may be a silicone and/or a low-durometer epoxy adhesive.

Yet another aspect of the invention pertains to a battery array comprising, in various embodiments, a plurality of thin-film batteries each having first and second opposed surfaces and a thickness spanning the surfaces, where the batteries have a generally polygonal (e.g., square) shape; a plurality of printed circuit boards each having first and second opposed surfaces; a separate battery mounted on and electrically connected to the first side of each of the boards; and a compliant pad over each of the batteries. The boards are arranged in stacked relation with the second side of all but one of the boards sandwiching the compliant pad in contact with the battery mounted on another of the boards.

In some embodiments, the battery array further comprises first and second electrical contacts on an exposed surface of at least one of printed circuit boards, with each of the contacts electrically connected to a different pole of all of the batteries.

The term “substantially” or “approximately” means ±10% (e.g., by weight or by volume), and in some embodiments, ±5%. The term “consists essentially” means excluding other materials that contribute to function, unless otherwise defined herein. Nonetheless, such other materials may be present, collectively or individually, in trace amounts. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

The foregoing will be more readily understood from the following detailed description of the invention, in particular, when taken in conjunction with the drawings, in which:

FIG. 1 is a transparent perspective view of a prior-art thin-film battery configuration.

FIG. 2 is an exploded view of a battery tray arrangement in accordance with embodiments of the present invention.

FIG. 3 is a perspective view of a stacked array of battery trays.

FIG. 4 is an elevational view of a sidewall of a stacked array of trays with conductive traces applied thereto to connect like battery terminals.

FIG. 5 is a perspective view of thin-film batteries arranged on a flexible printed circuit board.

FIG. 6 shows the structure of FIG. 5 folded to sandwich the batteries between accordion pleats.

FIG. 7A is a perspective view of a printed circuit board having a thin-film battery mounted thereon.

FIG. 7B shows a stacked series of printed circuit boards as illustrated in FIG. 7A.

FIG. 8 is a plan view of a tiled arrangement of four battery trays configured for convenient interconnection when stacked.

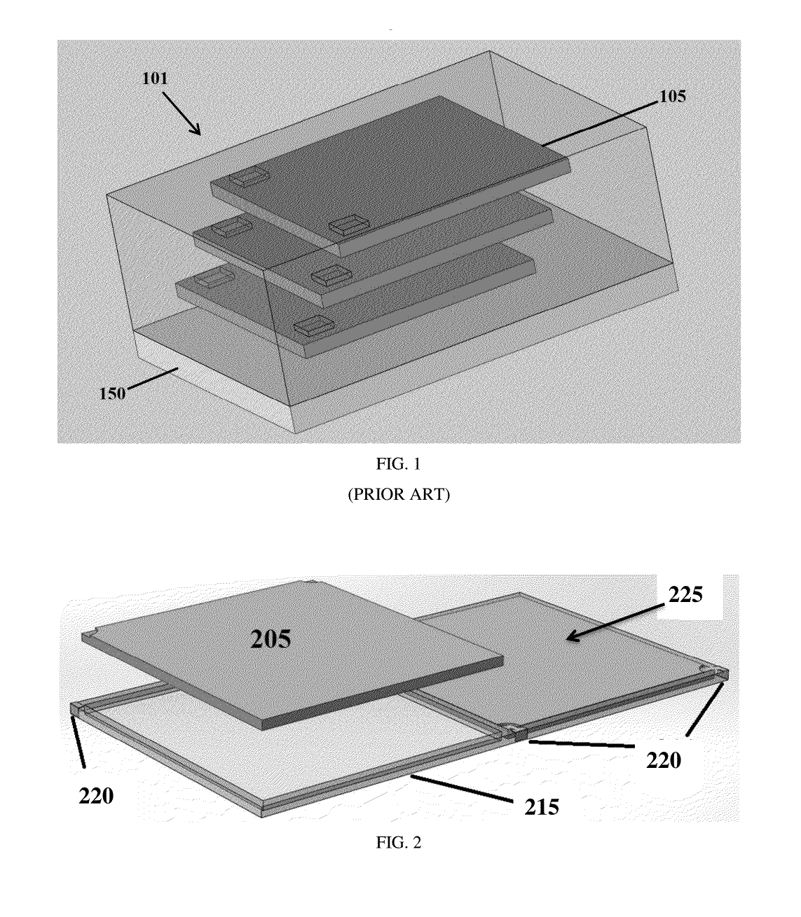

### DETAILED DESCRIPTION

In various embodiments, the present invention relates generally to stacked SSRBs and manufacturing techniques therefor. Various embodiments described below incorporate fabrication techniques used in stacking integrated circuits (ICs) to stack individually packaged and validated SSRBs while minimizing failure modes associated with packaged SSRBs.

In one embodiment, the SSRB is a LiPON thin-film solid-state battery. LiPON batteries may be manufactured by depositing thin layers of different materials on a substrate to form the anode, cathode, and electrolyte. After deposition of the functional battery components, the layers are typically sealed (e.g., by means of a laminate) to prevent chemical reactions caused by interaction with air that would shorten the battery life. The battery life is further extended by hermetically sealing the battery in an additional enclosure containing an inert gas such as argon. Prepackaged SSRBs may be purchased from manufacturers such as Cymbet Corporation, Excellatron Solid State LLC, Front Edge Technology Inc., Infinite Power Solutions Inc., and incorporated into the stack assemblies described herein.

Because thin-film solid-state batteries may have thicknesses on the order of 100 μm and area (length and width) dimensions on the order of 1 mm, several cells may be incorporated into a single arrangement to provide adequate voltage or capacity (by connecting the cells in series or in parallel, respectively) for a particular application. As noted earlier, direct stacking of batteries leads to failure modes caused by volumetric expansion of the battery during charging, which temporarily reduces the capacity of the battery or may even irreparably damage it. Therefore, embodiments of the present invention accommodate fluctuations in battery cell thickness during operation. For example, each thin-film battery may be isolated in an individual tray having sidewalls at least as tall as the battery thickness in its expanded state. A cushion layer may also be incorporated to protect the battery from applied pressures; the cushion layer may be made of a compliant polymeric material such as silicone or even a gas, or a combination of a polymer and a gas cushioning layer.

Stacking of Solid State Batteries with Trays

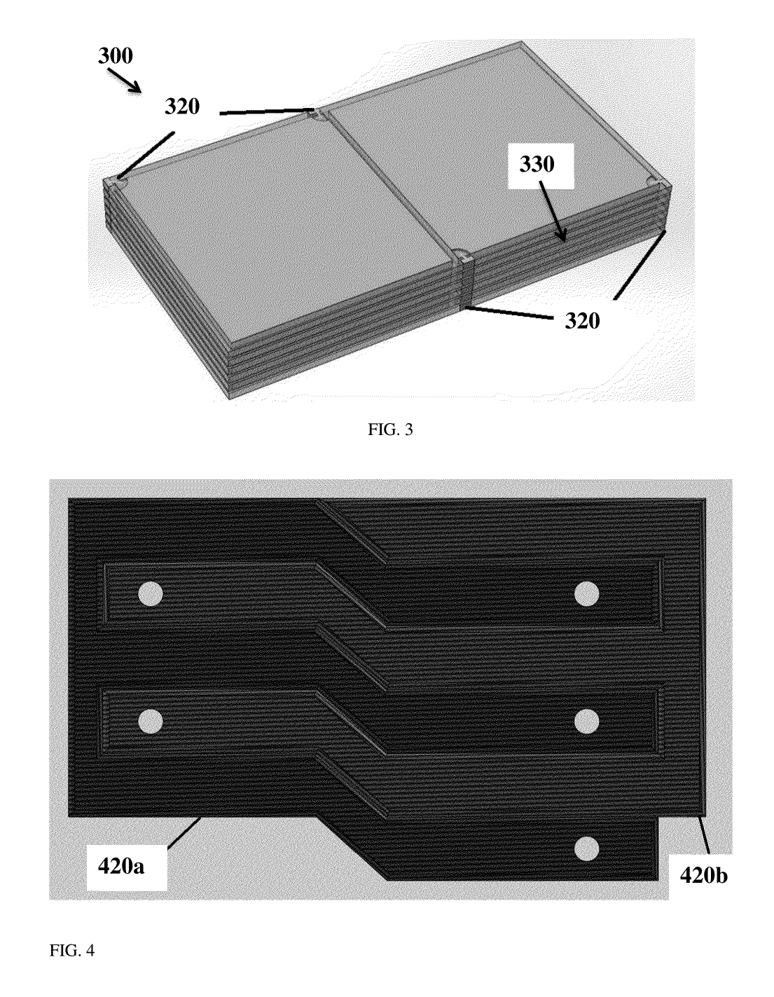

In one embodiment, as illustrated in FIG. 2, a pair of prepackaged solid state batteries 205 are received within individual trays 215, which can be stacked vertically (as shown in FIG. 4) and horizontally (as shown in FIG. 2) to create a custom battery stack having the capacity, size, and overall shape to match the device it will power.

The trays 215 may be fabricated from any nonconductive material having adequate mechanical strength and capable of being shaped to form the well and sidewalls, which are taller than the thickness of the batteries 205. In one embodiment, a pattern of trays 215 is created by first stamping a grid pattern in a substrate sheet; the resulting framework forms the sidewalls of the array of trays. The stamp may additionally create cutouts in the framework to accommodate the battery's electrical contacts 220 and/or separate tray electrical contacts exposed through the sidewalls. A thin substrate sheet is then epoxied to one side of the stamped framework sheet to form the tray bottoms. Electrical contacts 220 are thereupon inserted into (or applied to) the cutouts in the tray sidewalls. In these embodiments, the tray 215 may comprise, consist of or consist essentially of a polymer rigid enough to maintain structural integrity of the sidewalls in the environment of intended use. The polymer may consist of comprise, consist of or consist essentially of polyester film, polyethylene film, or polypropylene film, or any other suitable material known to those skilled in the art. The trays may have complementary mating features to retain them in a stacked configuration; for example, the peripheral bottom edge of a tray may be recessed to form a shoulder that fits snugly within the well of an underlying tray while still allowing space for battery expansion in that well.

Furthermore, this approach may be used to create multiple battery tray stacks simultaneously in a grid pattern and separated by a dicing saw to expose the contacts. Battery stacks may then be epoxied together to create various configurations. More generally, the stacked trays may be encapsulated or bonded together into a single rigid structure; for example, the trays may be bonded using epoxy or may be overmolded with an electrical potting solution or other encapsulant.

In another embodiment, the trays 215 are created using micro-fabrication techniques. A tray may be manufactured according to steps including coating a first photoresist layer onto a silicon substrate as a sacrificial layer, depositing a first material layer onto the photoresist layer to form a thin bottom layer that will become the tray bottom, and coating a second photoresist layer over the first material layer. A second material layer may then be deposited on the second photoresist layer, so that the second material layer forms the sidewall. Then the first and second material layers are patterned to form the tray and the first and second photoresist layers are removed, thereby leaving the formed tray. The patterning step may include reactive-ion etching with a photoresist material used as an etching mask, and/or patterning the first and second material layers using a photoresist mask. At least one of the coating steps may include spin-coating.

In one embodiment, the battery 205 is placed in the tray slot 250, the battery termini are connected to the tray electrical contacts 220 by, e.g., wire bonding. A thin (20 μm to 200 μm) silicone layer 225 is applied over the top surface of the battery 205 to prevent mechanical damage to the battery's active surface. Silicone may be applied, for example, by a spray coating process. The silicone may be diluted with a solvent/dispersant (e.g., heptane or xylene) to achieve thinner silicone layers. Following application of the silicone cushioning layer, epoxy is applied over the tray. A vacuum is applied to reduce air trapped between the tray and epoxy interface. Slight pressure may be applied to affix the epoxy. The finished tray is stacked over a previously finished tray, and this process is repeated until the desired stack height is achieved.

After tray assembly, the thin silicone layer cures with negligible off-gassing within the tray well. Curing may be accelerated by low-temperature baking that does not harm the battery. The silicone layer allows the battery to expand within the tray well without experiencing a buildup of pressure that may damage the battery and/or adjacent trays. By isolating each battery 205 within a trays 215, this stacking design prevents cumulative pressure buildup from the batteries when charging, which could spread throughout the stacked structure and fracture the batteries therein. Off-gassing may also create a gas cushion that supplements the silicone cushion,

In another embodiment, the silicone layer is cured prior to epoxy application and stacking. In this embodiment, the silicone layer alone accommodates fluctuation in battery cell thickness during operation, allowing for lower sidewalls than would be necessary to accommodate the off-gassed layer. This approach minimizes epoxy delamination caused by the off-gassed layer.

In various embodiments, the electrical terminals are exposed through the sidewall of the tray. The electrical terminals 220 are made of a conductive material such as gold and/or copper. The terminals 220 may be configured to contact the terminals of one or two adjacent (above and/or below) layers create stacked batteries that are connected in series or in parallel. As shown in FIG. 3, the trays may be stacked to form an array 300. The terminals of each layer may be separate or may be traversed by a single conductor 320, facilitating electrical connection to the like terminals of the entire battery array at a single point. A protective membrane may be applied over the top, or the whole battery stack may be electrically potted in a material that forms a battery shell package (which, among other things, prevents escape of any gas furnishing cushioning).

Another approach to connecting the terminals of a battery stack is shown in FIG. 4. A pair of interdigitated but electrically separate conductive traces 420a, 420b are applied (e.g., by screen printing, deposition, or other suitable application technique) to one of the sidewalls of a battery stack, e.g., the sidewall 330 shown in FIG. 3. In this case, the vertical end post of the conductor 420a makes contact with (i.e., traverses) the left-side terminals 320 on sidewall 330, and the vertical end post of of the conductor 420b separately makes contact with the right-side terminals 320 (bending around the sidewall 330 if necessary). A connection to each of the conductors 420a, 420b may be made at any of the finger-like ends thereof, once again providing a single connection point to all of the like battery terminals.

### Stacking of Batteries Using Flex Circuit Technology

Another approach to battery stacking utilizes a flexible printed circuit board (PCB) structure that is folded or stacked to provide a 3D scaffold. Flexible PCB is widely used in consumer electronics (e.g., cell phones) and medical devices (e.g., hearing aids). To adapt the approach to battery stacking, certain modifications are made to the traditional techniques.

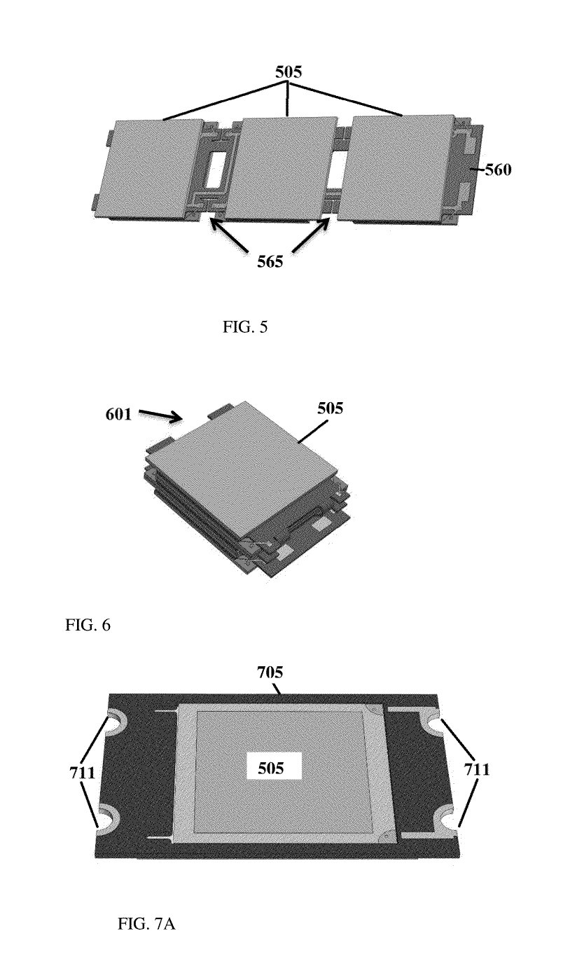

In one embodiment, the batteries are electrically connected to the “flex” (i.e., the PCB) via wire bonding. The flex provides both the mechanical structure for the stack and the electrical connections between the battery cells to connect them in parallel. The flex can also have stiffeners under the battery areas to relieve bending stress. With reference to FIG. 5, the six battery cells 505 are mounted facing the flex PCB 560 on both sides thereof, and their positions are staggered to expose the contact pads for wire bonding. This configuration is folded along the fold lines 565 to create the folded structure 601 shown in FIG. 6, which, while compact, allows space above the contact pads for wire bond. For mounting the battery cells 505 to the flex, a silicone or a soft epoxy adhesive is utilized. This is because the cell surface curvature changes during the charging process. The soft adhesive minimizes tension on the cell surface, thus preventing battery failure. The adhesive can be dispensed by stencil, programmed robotic system, or micropipette after diluting. In this embodiment, an outer wrapping may be applied to keep the structure from unfolding. The outer wrapping can be made of a stretch wrap, or heat-shrink tubing. The wrapping is typically less than 1 mil thick to minimize the compressive stress on the batteries.

In another embodiment, the batteries are electrically connected via solder. The solder can be applied as paste and then reflowed. In this embodiment, the adhesive selected needs to withstand the reflow temperature.

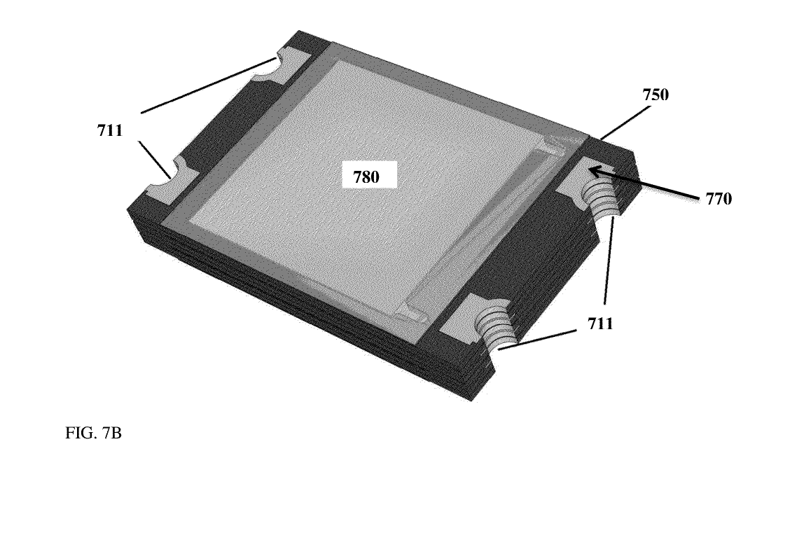

In yet another embodiment, illustrated in FIGS. 7A and 7B, the flex PCB 705 has cutout regions 711 that, when stacked into a single structure 750 as shown in FIG. 7B, form half of a via. The battery terminals of each layer are connected to the right-side conductors on the cutout regions 711. When the structure 750 is butted against another structure 750 the full vias are formed, and can accommodate a structural post, which may also be electrically conductive to establish connection to one set of the battery terminals of the structure 750 by means of the conductors on the cutout regions 711. Alternatively, electrical connection to the battery terminals may be established by wire-bonding to the pads 770 surrounding the cutout regions 711 (and which, when stacked, electrically connect the terminals of vertically adjacent layers 705); solder can be used to bridge all the layers through the via, providing both electrical connection and structural bonding. A thin plastic film 780 can overlie the exposed battery 505. In this embodiment, the film 780 can start as a ribbon structure, with thin layer of adhesive applied. The film can be made of a polyester material and the adhesive can be an epoxy. After attachment of the flex circuit, the film and the battery cell, the adhesive can be cured to affix the components in place.

### Encapsulated Battery Stacking

To create a battery stack that is both mechanically sound and volume-efficient, SSRBs may be encapsulated in epoxy or other suitable high-durometer material in a manner similar to how IC multi-chip modules are built. In one embodiment, the cells are stacked and connections made by wire-bonding or other connection technique, and the stack is then encapsulated in epoxy or the equivalent. In another embodiment, connections to each cell are first made by wire-bonding or other connection technique and the single layer is encapsulated; the encapsulated cells are then stacked together. Unlike IC stacking technology, the encapsulation process creates a very thin void or low-durometer material (e.g., silicone) on top of the active part of the battery cell. This additional layer should be very thin (5 to 20 μm) so as not to adversely affect the volume efficiency.

An important limitation of lithium-based rechargeable batteries is their sensitivity to temperature once charged. Before their first charge they can be exposed to fairly high temperatures, up to a few hundred degrees Celsius. However, once fully charged (e.g., to 4.1V), the maximum temperature they can be exposed to is greatly reduced, typically not more than 60° C. The maximum temperature can be increased slightly to about 80° C. by reducing the charge voltage to a level where the charge taken by the battery is <20% of the rated capacity (e.g., 3.9V). Therefore, testing of the battery cells before encapsulation is neither practical nor desired because it requires probing, and high-temperature exposure is needed as part of the manufacturing process.

The ability to test each encapsulated battery cell before stacking, however, is desired to avoid large yield loss, at least before the manufacturing process has reached a certain level of maturity: because of the number of cells in a stack (frequently more than 10) and the fact that the entire stack is unusable if only one of the constituent cells has a defect, the probability of failure is extremely high if the encapsulation is not yet perfectly controlled. But testing requires that the temperature exposure during the rest of the battery-stack manufacturing process be limited to no more than 80° C. and that the test be performed with the reduced-charge voltage. Also, once charged, at no time during the rest of the manufacturing process can the positive and negative terminals of the cells be shorted (during metallization for instance in the case of using sidewalls and laser etching to connect contacts).

The final test of the battery stack must also reflect the expected temperature exposure during assembly of the device that will receive the battery. If high temperatures are not involved then testing at full charge can be done, although if temperatures up to 80° C. are required, the test must be performed at the reduced-charge voltage.

### Manufacturing and Testing of Battery Array

As described above, there are many impediments to reliable fabrication creation of a battery array with a plurality of thin-film batteries. In a simplified work flow designed to increase yield, two thin-film batteries are oriented next to each other and electrical terminals connections are created in parallel (e.g., wire-bonding). Next, the resulting battery layer is encapsulated by one of the above-described techniques with either a controlled void or high-compliance material adjacent to the batteries' active part, but leaving one or more electrical terminals accessible. The encapsulated battery layer may optionally be tested at low charge voltage at this time. Multiple encapsulated layers may be combined (e.g., using epoxy with a curing temperature of less than 80° C.). Next, a sidewall is metalized and etched to connect the electrical terminals of various layers. Once again, the encapsulated battery layers may optionally be tested at low charge voltage at this time. Depending to the configuration, the various modules created by the previous steps may further be combined. Finally, the completed battery undergoes a final test. This iterative manufacturing and testing process allows for high-yield output with the option of various modular outputs using already-manufactured thin-film batteries.

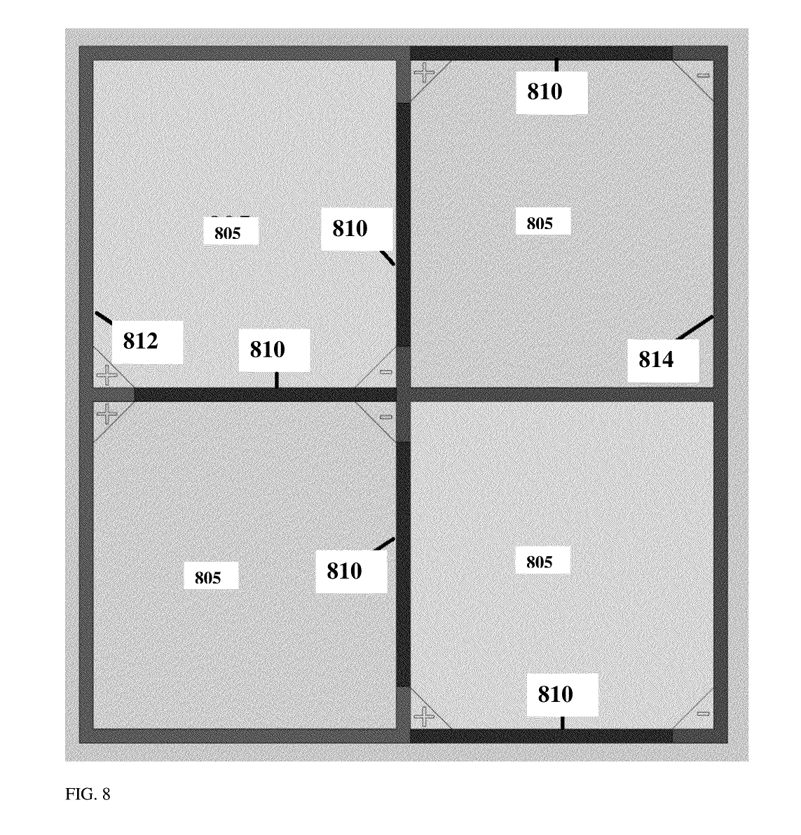

Although the embodiments above focused on designs of one or two thin-film batteries per layer, this can be expanded to higher numbers. For example, as shown in FIG. 8, more than two battery cells (in the illustrated embodiment, four) are tiled on each layer. In FIG. 8, the four batteries 805 are arranged with adjacent batteries alternating in orientation. The four individual encapsulated batteries 805 are then fused with a non-conductive epoxy 810 in some areas and a conductive epoxy in other areas where an electrical connection (positive terminal traces 812, negative terminal traces 814) is to be made.

Having described certain embodiments of the invention, it will be apparent to those of ordinary skill in the art that other embodiments incorporating the concepts disclosed herein may be used without departing from the spirit and scope of the invention. For example, various features described with respect to one particular device type and configuration may be implemented in other types of devices and alternative device configurations as well. Accordingly, the described embodiments are to be considered in all respects as only illustrative and not restrictive.

What is claimed is:

1. A battery array comprising:
a plurality of thin-film batteries each having first and second opposed surfaces and a thickness spanning the surfaces, the batteries having a generally polygonal shape; and
a plurality of battery trays, each of the trays having at least one battery well and an associated battery received therein, each of the battery wells comprising (i) a floor in contact with a first surface of the associated battery, (ii) a side wall having a height greater than the thickness of the associated battery, and (iii) first and second electrical contacts on an exterior surface of the side wall, each of the contacts being electrically connected to a different pole of the associated battery,
wherein the battery trays are arranged in stacked relation, the first electrical contacts being interconnected with each other and the second electrical contacts being interconnected with each other but not with the first electrical contacts, and further wherein in each well, a second surface of the associated battery opposed to the battery first surface is spaced apart from any surface of any tray stacked thereabove.

2. The battery array of claim 1, wherein each of the battery trays has first and second battery wells arranged side-by-side.

3. The battery array of claim 1, wherein each of the battery trays has at least four battery wells arranged in a tiled configuration wherein a first pair of battery trays adjacent along a first axis has electrical contacts in a first configuration and a second pair of battery trays adjacent to each other along the first axis and adjacent to the first pair of battery trays along a second axis perpendicular to the first axis has electrical contacts in a second configuration different from the first configuration.

4. The battery array of claim 3, further comprising a first conductive epoxy interconnecting the first electrical contacts, a second conductive epoxy interconnecting the second electrical contacts, and a non-conductive epoxy separating the first and second electrical contacts.

5. The battery array of claim 1, further comprising first and second interdigitated conductors along a sidewall thereof, the first conductor being connected to the first electrical contacts and the second conductor being separately connected to the second electrical contacts.

6. The battery array of claim 1, wherein each of the wells further comprises a compliant pad over the associated battery.

7. The battery array of claim 1, wherein the trays comprise or consist essentially of polyester, polyethylene, or polypropylene.

8. The battery array of claim 1, wherein the compliant pad comprises at least one of silicone, low-durometer epoxy, or a gas layer.

9. The battery array of claim 1, wherein the stacked battery trays are bonded together or encapsulated.

10. The battery array of claim 1 wherein the batteries are LiPON thin-film solid-state batteries.

11. A battery array comprising:
a plurality of thin-film batteries each having first and second opposed surfaces and a thickness spanning the surfaces, the batteries having a generally polygonal shape;
a flexible printed circuit board folded in an accordion fashion to create pairs of opposed board surfaces, each pair of opposed surfaces having at least one battery received therebetween;
first and second electrical contacts on an exposed surface of the flexible printed circuit board, each of the contacts being electrically connected to a different pole of all of the batteries; and
a compliant pad over each battery.

12. The battery array of claim 11, further comprising a support structure for retaining the flexible printed circuit board in a folded configuration.

13. The battery array of claim 12, wherein the support structure is an external wrap consisting of stretch wrap or heat shrink tubing.

14. The battery array of claim 11, wherein the compliant pad is at least one of a silicone or a low-durometer epoxy adhesive.

15. A battery array comprising:
a plurality of thin-film batteries each having first and second opposed surfaces and a thickness spanning the surfaces, the batteries having a generally polygonal shape;
a plurality of printed circuit boards each having first and second opposed surfaces;
a separate battery mounted on and electrically connected to the first side of each of the boards; and
a compliant pad over each of the batteries,
wherein the boards are arranged in stacked relation with the second side of all but one of the boards sandwiching the compliant pad in contact with the battery mounted on another of the boards.

16. The battery array of claim 15, further comprising first and second electrical contacts on an exposed surface of at least one of printed circuit boards, each of the contacts being electrically connected to a different pole of all of the batteries.
